(19) United States
(12) Patent Application Publication
(10) Pub. No.: US 2020/0193833 A1
(43) Pub. Date: Jun. 18, 2020

(54) DRIVING SUPPORT APPARATUS, VEHICLE, CONTROL METHOD FOR DRIVING SUPPORT APPARATUS, AND STORAGE MEDIUM

(71) Applicant: HONDA MOTOR CO., LTD., Tokyo (JP)

(72) Inventor: Hideki Matsunaga, Wako-shi (JP)

(73) Assignee: HONDA MOTOR CO., LTD., Tokyo (JP)

(21) Appl. No.: 16/699,335

(22) Filed: Nov. 29, 2019

(30) Foreign Application Priority Data
Dec. 12, 2018 (JP) 2018-232806

(51) Int. Cl. G08G 1/16; G05D 1/02

(52) U.S. Cl. CPC G08G 1/167; G05D 2201/0212; G05D 1/0212

(57) ABSTRACT

A driving support apparatus for supporting driving of a moving body comprises a margin estimation unit configured to estimate a margin in a driving status of the moving body. The margin estimation unit determines, based on the margin, whether another moving body that is to merge with a traveling lane of the moving body is allowed to merge in front of the moving body.

### CROSS-REFERENCE TO RELATED APPLICATION(S)

This application claims priority to and the benefit of Japanese Patent Application No. 2018-232806 filed on Dec. 12, 2018, the entire disclosure of which is incorporated herein by reference.

### BACKGROUND OF THE INVENTION

### Field of the Invention

The present invention relates to a driving support apparatus, a vehicle, a control method for the driving support apparatus, and a storage medium.

### Description of the Related Art

Japanese Patent Laid-Open No. 2017-181449 discloses, as an arrangement of performing a route search with high user satisfaction, an electronic apparatus for setting a route based on stress information of a user.

In the arrangement disclosed in Japanese Patent Laid-Open No. 2017-181449, however, it is difficult to reflect, on control of a vehicle, a driving status during traveling of the vehicle. For example, when another moving body (another vehicle) enters (for example, merges from another lane) a lane on which a moving body (self-vehicle) travels, if too many other moving bodies are allowed to enter, the traveling plan of the moving body (self-vehicle) may be delayed, and an uncomfortable feeling is given to an occupant of the self-vehicle, thereby giving mental stress.

In the arrangement of the electronic apparatus disclosed in Japanese Patent Laid-Open No. 2017-181449, it is difficult to execute vehicle control to suppress stress on an occupant by making the moving body (self-vehicle) travel based on a plan while making another moving body (another vehicle) smoothly travel as a traffic environment around the moving body.

### SUMMARY OF THE INVENTION

The present invention provides a driving support technique capable of performing driving support while keeping the balance between traveling of another moving body (another vehicle) as a peripheral traffic environment and planned traveling of a moving body (self-vehicle).

According to one aspect of the present invention, there is provided a driving support apparatus for supporting driving of a moving body, comprising: a margin estimation unit configured to estimate a margin in a driving status of the moving body, wherein the margin estimation unit determines, based on the margin, whether another moving body that is to merge with a traveling lane of the moving body is allowed to merge in front of the moving body.

According to another aspect of the present invention, there is provided a control method for a driving support apparatus that supports driving of a moving body, comprising: a margin estimation step of estimating a margin in a driving status of the moving body, wherein in the margin estimation step, it is determined, based on the margin, whether another moving body that is to merge with a traveling lane of the moving body is allowed to merge in front of the moving body.

According to the present invention, it is possible to perform driving support while keeping the balance between traveling of another moving body as a peripheral traffic environment and planned traveling of a moving body.

Further features of the present invention will become apparent from the following description of exemplary embodiments (with reference to the attached drawings).

### BRIEF DESCRIPTION OF THE DRAWINGS

FIG. 1 is a block diagram showing a driving support apparatus according to an embodiment;

FIG. 2 is a block diagram showing the driving support apparatus according to the embodiment;

FIG. 3 is a block diagram showing the driving support apparatus according to the embodiment;

FIGS. 4A and 4B are flowcharts for explaining the procedure of the processing of the driving support apparatus according to the embodiment;

FIG. 5 is a timing chart schematically showing a time-series change in margin;

FIG. 6 is a view schematically showing traveling scenes; and

FIG. 7 is a table exemplifying a table that associates the number of merging vehicles and the decrease amount of a margin with each other.

### DESCRIPTION OF THE EMBODIMENTS

### First Embodiment

An embodiment of the present invention will be described below with reference to the accompanying drawings. Components to be described in this embodiment are merely examples and are not limited by the following embodiment.

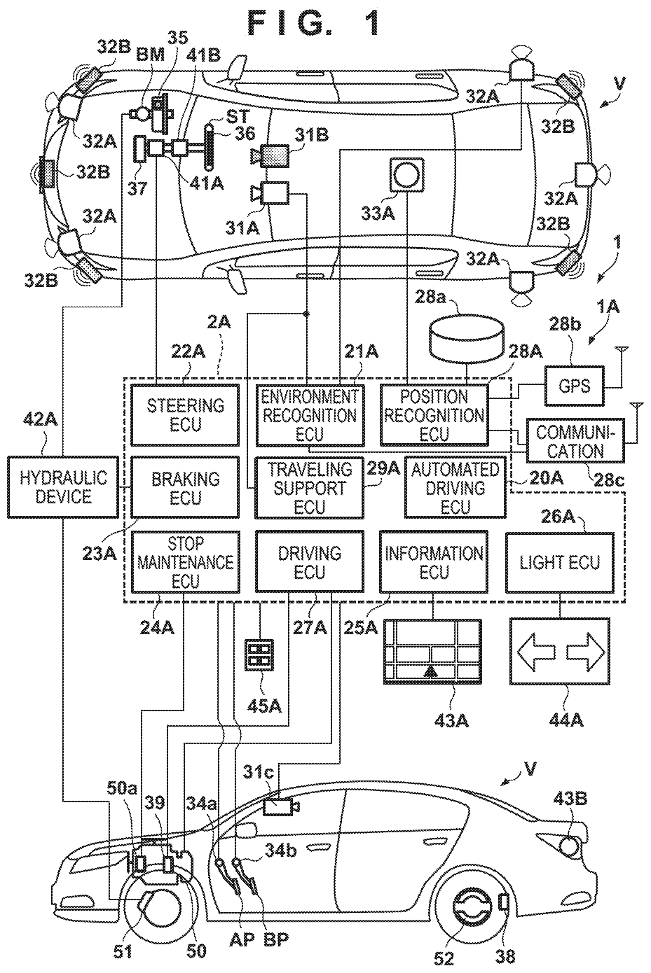

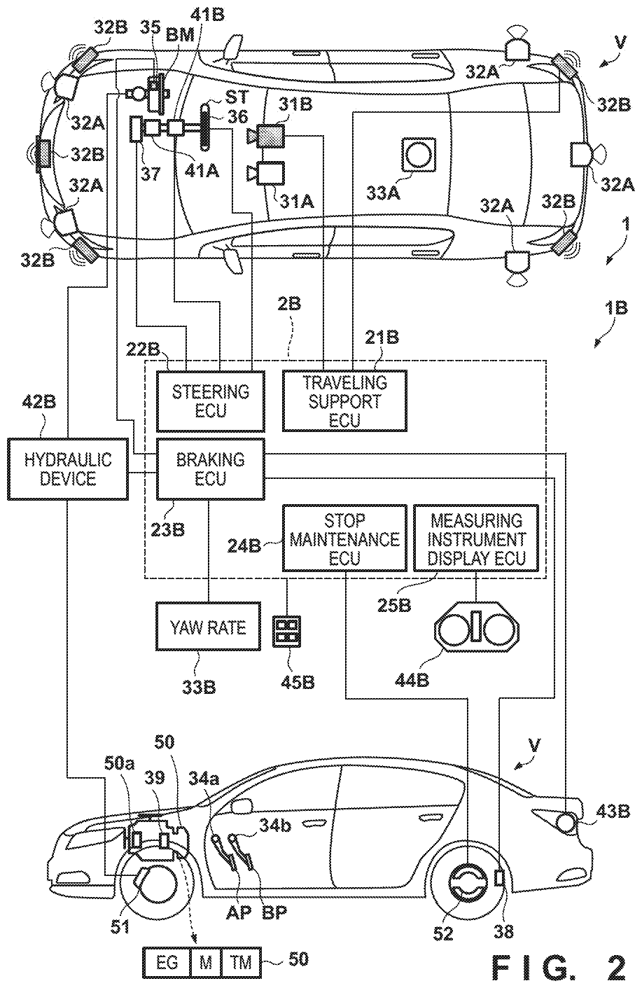

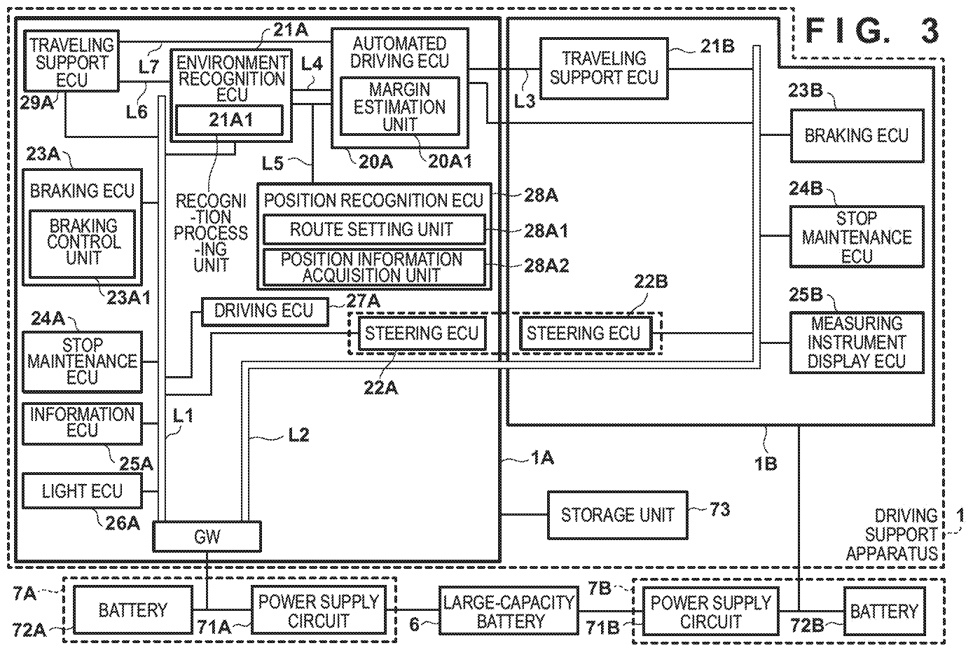

FIGS. 1 to 3 are block diagrams each showing a driving support apparatus 1 according to the embodiment of the present invention. The driving support apparatus 1 controls a vehicle V. Referring to FIGS. 1 and 2, plan views and side views show an outline of the vehicle V. As an example, the vehicle V is a sedan-type four-wheeled vehicle. The driving support apparatus 1 includes control apparatuses 1A and 1B. FIG. 1 is a block diagram showing the control apparatus 1A, and FIG. 2 is a block diagram showing the control apparatus 1B. FIG. 3 mainly shows the arrangement of power supplies and communication lines between the control apparatuses 1A and 1B.

The control apparatuses 1A and 1B multiplex some of functions implemented by the vehicle V or make some of the functions redundant. This can improve the reliability of the system. The control apparatus 1A performs, for example, traveling support control concerning risk aversion or the like in addition to automated driving control and normal operation control in manual driving. The control apparatus 1B mainly manages traveling support control concerning risk aversion or the like. Traveling support will be sometimes referred to as driving support hereinafter. By making functions redundant in the control apparatuses 1A and 1B and causing them to perform different control processes, it is possible to distribute control processing and improve the reliability.

The vehicle V according to this embodiment is a parallel hybrid vehicle. FIG. 2 schematically shows the arrangement of a power plant 50 that outputs a driving force to rotate the driving wheels of the vehicle V. The power plant 50 includes an internal combustion engine EG, a motor M, and an automatic transmission TM. The motor M can be used as a driving source that accelerates the vehicle V and also used as an electric generator at the time of deceleration or the like (regenerative braking).

<Control Apparatus 1A>

The arrangement of the control apparatus 1A will be described with reference to FIG. 1. The control apparatus 1A includes an ECU (Electronic Control Unit) group (control unit group) 2A. The ECU group 2A includes a plurality of ECUs 20A to 29A. Each ECU includes a processor represented by a CPU, a storage device such as a semiconductor memory, and an interface with an external device. The storage device stores a program to be executed by the processor, data to be used by the processor for processing, and the like. Each ECU may include a plurality of processors, a plurality of storage devices, and a plurality of interfaces. Note that the number of ECUs and functions provided by the ECUs can be designed appropriately, and the ECUs can be subdivided or integrated, as compared with this embodiment. Note that FIGS. 1 and 3 show the names of the representative functions of the ECUs 20A to 29A. For example, the ECU 20A is represented as an “automated driving ECU”.

The ECU 20A executes control concerning automated driving as traveling control of the vehicle V. In automated driving, at least one of driving (acceleration of the vehicle V by the power plant 50 or the like), steering, and braking of the vehicle V is automatically performed regardless of a driving operation of a driver. In this embodiment, driving, steering, and breaking are automatically performed.

The ECU 21A serves as an environment recognition unit that recognizes the traveling environment of the vehicle V based on the detection results of detection units 31A and 32A for detecting the peripheral status of the vehicle V. The ECU 21A generates target data (to be described later) as peripheral environment information.

In this embodiment, the detection unit 31A serves as an image capturing device (to be sometimes referred to as the camera 31A hereinafter) that detects an object around the vehicle V by image capturing. The camera 31A is attached to the windshield inside the vehicle cabin at the roof front of the vehicle V to capture the front side of the vehicle V. When images captured by the camera 31A are analyzed, the contour of a target or a division line (a white line or the like) of a lane on a road can be extracted.

In this embodiment, the detection unit 32A serves as a LIDAR (Light Detection and Ranging) (to be sometimes referred to as the LIDAR 32A hereinafter) that detects an object around the vehicle V using light, and detects a target around the vehicle V and measures a distance to the target. In this embodiment, five LIDARs 32A are provided one at each corner of the front portion of the vehicle V one at the center of the rear portion, and one on each side of the rear portion. The number of LIDARs 32A and their arrangement can be selected appropriately.

The ECU 29A serves as a traveling support unit that executes control concerning traveling support (in other words, driving support) as traveling control of the vehicle V based on the detection result of the detection unit 31A.

The ECU 22A serves as a steering control unit that controls an electric power steering device 41A. The electric power steering device 41A includes a mechanism that steers front wheels in accordance with a driving operation (steering operation) of the driver on a steering wheel ST. The electric power steering device 41A includes a motor that generates a driving force to assist the steering operation or automatically steer the front wheels, a sensor that detects the rotation amount of a motor, and a torque sensor that detects a steering torque borne by the driver.

The ECU 23A serves as a braking control unit that controls a hydraulic device 42A. A braking operation of the driver on a brake pedal BP is converted into a hydraulic pressure in a brake master cylinder BM, and transferred to the hydraulic device 42A. The hydraulic device 42A is an actuator that can control, based on the hydraulic pressure transferred from the brake master cylinder BM, the hydraulic pressure of hydraulic oil to be supplied to a brake device (for example, a disc brake device) 51 provided in each of the four wheels, and the ECU 23A controls driving of a solenoid valve or the like provided in the hydraulic device 42A. In this embodiment, the ECU 23A and the hydraulic device 42A form an electric servo brake, and the ECU 23A controls distribution of, for example, braking forces generated by the four brake devices 51 and a braking force generated by regenerative braking of the motor M.

The ECU 24A serves as a stop maintenance control unit that controls an electric parking lock device 50a provided in the automatic transmission TM. The electric parking lock device 50a mainly includes a mechanism that locks the internal mechanism of the automatic transmission TM at the time of selection of a P range (parking range). The ECU 24A can control locking and unlocking by the electric parking lock device 50a.

The ECU 25A serves as an internal notification control unit that controls an information output device 43A for making a notification of information inside the vehicle. The information output device 43A includes, for example, a voice output device and a display device such as a head-up display. The information output device 43A may further include a vibration device. The ECU 25A causes the information output device 43A to output, for example, various kinds of information such as a vehicle speed and an outside air temperature and information such as route guidance.

The ECU 26A serves as an external notification control unit that controls an information output device 44A for making a notification of information outside the vehicle. In this embodiment, the information output device 44A is a direction indicator (hazard lamp), and the ECU 26A can make a notification of the advancing direction of the vehicle V outside the vehicle by controlling blinking of the information output device 44A as a direction indicator, and raise the attention of the outside to the vehicle V by controlling blinking of the information output device 44A as a hazard lamp.

The ECU 27A serves as a driving control unit that controls the power plant 50. In this embodiment, one ECU 27A is assigned to the power plant 50 but one ECU may be assigned to each of the internal combustion engine EG, the motor M, and the automatic transmission TM. The ECU 27A controls the outputs of the internal combustion engine EG and motor M and switches the gear range of the automatic transmission TM in accordance with a driving operation of the driver, the vehicle speed, and the like detected by an operation detection sensor 34a provided in an accelerator pedal AP and an operation detection sensor 34b provided in the brake pedal BP. Note that a rotation speed sensor 39 that detects the rotation speed of the output shaft of the automatic transmission TM is provided, in the automatic transmission TM, as a sensor that detects the traveling state of the vehicle V. The vehicle speed of the vehicle V can be calculated based on the detection result of the rotation speed sensor 39.

The ECU 28A serves as a position recognition unit that recognizes the current position and course of the vehicle V. The ECU 28A controls a gyro sensor 33A, a GPS sensor 28b, and a communication device 28c, and performs information processing of a detection result or a communication result. The gyro sensor 33A detects a rotary motion of the vehicle V. The course of the vehicle V can be determined based on the detection result of the gyro sensor 33A and the like. The GPS sensor 28b detects the current position of the vehicle V. The communication device 28c performs wireless communication with a server that provides map information or traffic information and acquires these pieces of information. A database 28a can store high-precision map information, and the ECU 28A can specify the position of the vehicle V on the lane more precisely based on the map information and the like.

An input device 45A is arranged in the vehicle so as to be operable by the driver, and accepts input of an instruction or information from the driver.

<Control Apparatus 1B>

The arrangement of the control apparatus 1B will be described with reference to FIG. 2. The control apparatus 1B includes an ECU group (control unit group) 2B. The ECU group 2B includes a plurality of ECUs 21B to 25B. Each ECU includes a processor represented by a CPU, a storage device such as a semiconductor memory, and an interface with an external device. The storage device stores a program to be executed by the processor, data to be used by the processor for processing, and the like. Each ECU may include a plurality of processors, a plurality of storage devices, and a plurality of interfaces. Note that the number of ECUs and functions provided by the ECUs can be designed appropriately, and the ECUs can be subdivided or integrated, as compared with this embodiment. Note that FIGS. 2 and 3 show the names of the representative functions of the ECUs 21B to 25B, similar to the ECU group 2A.

The ECU 21B serves as an environment recognition unit that recognizes the traveling environment of the vehicle V based on the detection results of detection units 31B and 32B for detecting the peripheral status of the vehicle V, and also serves as a traveling support unit that executes control concerning traveling support (in other words, driving support) as traveling control of the vehicle V. The ECU 21B generates target data (to be described later) as peripheral environment information.

Note that in this embodiment, the ECU 21B is configured to have the environment recognition function and the traveling support function. However, an ECU may be provided for each function, like the ECUs 21A and 29A of the control apparatus 1A. To the contrary, the control apparatus 1A may have an arrangement in which the functions of the ECUs 21A and 29A are implemented by one ECU, like the ECU 21B.

In this embodiment, the detection unit 31B serves as an image capturing device (to be sometimes referred to as the camera 31B hereinafter) that detects an object around the vehicle V by image capturing. The camera 31B is attached to the windshield inside the vehicle cabin at the roof front of the vehicle V to capture the front side of the vehicle V. When images captured by the camera 31B are analyzed, the contour of a target or a division line (a white line or the like) of a lane on a road can be extracted. In this embodiment, the detection unit 32B serves as a millimeter wave radar (to be sometimes referred to as the radar 32B hereinafter) that detects an object around the vehicle V using a radio wave, and detects a target around the vehicle V and measures a distance to the target. In this embodiment, five radars 32B are provided; one at the center of the front portion of the vehicle V one at each corner of the front portion, and one at each corner of the rear portion. The number of radars 32B and their arrangement can be selected appropriately.

The ECU 22B is a steering control unit that controls an electric power steering device 41B. The electric power steering device 41B includes a mechanism that steers the front wheels in accordance with a driving operation (steering operation) of the driver on the steering wheel ST. The electric power steering device 41B includes a motor that generates a driving force to assist the steering operation or automatically steer the front wheels, a sensor that detects the rotation amount of a motor, and a torque sensor that detects a steering torque borne by the driver. A steering angle sensor 37 is electrically connected to the ECU 22B via a communication line L2 (to be described later), and it is possible to control the electric power steering device 41B based on the detection result of the steering angle sensor 37. The ECU 22B can acquire the detection result of a sensor 36 that detects whether the driver grips the steering wheel ST, and can monitor the gripping state of the driver.

The ECU 23B serves as a braking control unit that controls a hydraulic device 42B. A braking operation of the driver on the brake pedal BP is converted into a hydraulic pressure in the brake master cylinder BM, and transferred to the hydraulic device 42B. The hydraulic device 42B is an actuator that can control, based on the hydraulic pressure transferred from the brake master cylinder BM, the hydraulic pressure of hydraulic oil to be supplied to the brake device 51 of each wheel, and the ECU 23B controls driving of a solenoid valve or the like provided in the hydraulic device 42B.

In this embodiment, wheel speed sensors 38 respectively provided in the four wheels, a yaw rate sensor 33B, and a pressure sensor 35 that detects a pressure in the brake master cylinder BM are electrically connected to the ECU 23B and the hydraulic device 42B, thereby implementing, based on the detection results of these sensors, an ABS function, traction control, and a function of controlling the orientation of the vehicle V. For example, the ECU 23B adjusts the braking force of each wheel based on the detection result of the wheel speed sensor 38 provided in each of the four wheels, thereby suppressing sliding of each wheel. In addition, the braking force of each wheel is adjusted based on the rotation angular velocity around the vertical axis of the vehicle V, that has been detected by the yaw rate sensor 33B, thereby suppressing an abrupt change in orientation of the vehicle V.

The ECU 23B also functions as an external notification control unit that controls an information output device 43B for making a notification of information outside the vehicle. In this embodiment, the information output device 43B serves as a brake lamp, and the ECU 23B can turn on the brake lamp at the time of braking or the like. This can raise the attention of a following vehicle to the vehicle V.

The ECU 24B serves as a stop maintenance control unit that controls an electric parking brake device (for example, a drum brake) 52 provided in each rear wheel. The electric parking brake device 52 includes a mechanism that locks the rear wheel. The ECU 24B can control locking and unlocking of the rear wheels by the electric parking brake devices 52.

The ECU 25B serves as an internal notification control unit that controls an information output device 44B for making a notification of information inside the vehicle. In this embodiment, the information output device 44B includes a display device arranged in an instrument panel. The ECU 25B can cause the information output device 44B to output various kinds of information such as a vehicle speed and fuel consumption.

An input device 45B is arranged in the vehicle so as to be operable by the driver, and accepts input of an instruction or information from the driver.

<Communication Line>

Examples of communication lines of the driving support apparatus 1, that communicably connect the ECUs, will be described with reference to FIG. 3. The driving support apparatus 1 includes wired communication lines L1 to L7. The ECUs 20A to 27A and 29A of the control apparatus 1A are connected to the communication line L1. Note that the ECU 28A may also be connected to the communication line L1.

The ECUs 21B to 25B of the control apparatus 1B are connected to the communication line L2. The ECU 20A of the control apparatus 1A is also connected to the communication line L2. The communication line L3 connects the ECUs 20A and 21B. The communication line LA connects the ECUs 20A and 21A. The communication line L5 connects the ECUs 20A, 21A, and 28A. The communication line L6 connects the ECUs 29A and 21A. The communication line L7 connects the ECUs 29A and 20A.

The communication lines L1 to L7 may use the same protocol or different protocols, and may use different protocols in accordance with a communication environment such as a communication speed, communication amount, or durability. For example, the communication lines L3 and LA may use Ethernet® in terms of the communication speed. For example, the communication lines L1, L2 and L5 to L7 may use CAN.

The control apparatus 1A includes a gateway GW. The gateway GW relays the communication lines L and L2. Therefore, for example, the ECU 21B can output a control command to the ECU 27A via the communication line L2, the gateway GW, and the communication line L1.

<Power Supply>

The power supply of the driving support apparatus 1 will be described with reference to FIG. 3. The driving support apparatus 1 includes a large-capacity battery 6 and power supplies 7A and 7B. The large-capacity battery 6 is a battery that is used to drive the motor M and is charged by the motor M.

The power supply 7A is a power supply that supplies power to the control apparatus 1A, and includes a power supply circuit 71A and a battery 72A. The power supply circuit 71A is a circuit that supplies power of the large-capacity battery 6 to the control apparatus 1A, and lowers, for example, the output voltage (for example, 190 V) of the large-capacity battery 6 to a reference voltage (for example, 12 V). The battery 72A is, for example, a 12-V lead battery. By providing the battery 72A, it is possible to supply power to the control apparatus 1A even if power supply of the large-capacity battery 6 or the power supply circuit 71A is interrupted or decreases.

The power supply 7B is a power supply that supplies power to the control apparatus 1B, and includes a power supply circuit 71B and a battery 72B. The power supply circuit 71B is a circuit similar to the power supply circuit 71A, and a circuit that supplies power of the large-capacity battery 6 to the control apparatus 1B. The battery 72B is a battery similar to the battery 72A, and is, for example, a 12-V lead battery. By providing the battery 72B, it is possible to supply power to the control apparatus 1B even if power supply of the large-capacity battery 6 or the power supply circuit 71B is interrupted or decreases.

<Redundancy>

It is possible to improve the reliability of the driving support apparatus 1 by providing common functions to be redundant in the apparatus arrangements of the control apparatuses 1A and 1B. With respect to some of the functions made redundant, not completely the same functions are multiplexed and different functions are exhibited. This can suppress an increase in cost due to redundancy of the functions.

In the control apparatus 1A, an automated driving function including a driving support function is made redundant. The control apparatus 1A includes the ECU 20A that controls automated driving and the ECU 29A that controls traveling support, and includes two control units that control traveling.

<Example of Control Function>

Control functions executable in the control apparatus 1A or 1B include a traveling-related function concerning control of driving, braking, and steering of the vehicle V and a notification function concerning notification of information to the driver.

Examples of the traveling-related function are lane maintaining control, lane deviation suppression control (road deviation suppression control), lane change control, preceding vehicle follow-up control, collision reduction brake control, erroneous start suppression control, and driving support control when another moving body (another vehicle) merges with a traveling lane on which a moving body (self-vehicle) travels. Examples of the notification function are adjacent vehicle notification control and preceding vehicle start notification control.

Lane maintaining control is one of functions of controlling the position of the vehicle with respect to a lane, and is control of making the vehicle travel automatically (independently of the driving operation of the driver) on a traveling track set in the lane. Lane deviation suppression control is one of functions of controlling the position of the vehicle with respect to a lane, and detects a white line or a median strip and performs steering automatically so the vehicle does not exceed the line. As described above, lane deviation suppression control and lane maintaining control are different functions.

Lane change control is control of automatically moving the vehicle from the lane on which the vehicle currently travels to an adjacent lane. Preceding vehicle follow-up control is control of automatically following another vehicle traveling in front of the moving body (self-vehicle). Collision reduction brake control is control of supporting collision avoidance by automatic braking when the possibility of collision with an obstacle in front of the vehicle becomes high. Erroneous start suppression control is control of restricting acceleration of the vehicle when the driver performs a predetermined amount or more of an acceleration operation in the stop state of the vehicle, thereby suppressing a sudden start.

Adjacent vehicle notification control is control of notifying the driver of the existence of another vehicle traveling on the lane adjacent to the traveling lane of the moving body (self-vehicle), and notifies the driver of, for example, the existence of another vehicle traveling on the lateral side or rear side of the self-vehicle. Preceding vehicle start notification control is control of making a notification that the self-vehicle and another vehicle in front of it are in a stop state and the other vehicle starts. These notifications can be made by the above-described internal notification devices (information output devices 43A and 44B).

Driving support control is cooperative traveling control of keeping the balance between traveling of another moving body (another vehicle) as a peripheral traffic environment and planned traveling of the moving body (self-vehicle), and executes control of determining, based on a control parameter called a margin, whether to allow another moving body (another vehicle) that merges with the traveling lane of the moving body (self-vehicle) to merge in front of the moving body.

The ECUs 20A, 29A, and 21B can share and execute these control functions. It is possible to appropriately select a specific control function to be assigned to a specific ECU.

<Driving Support Control>

In this embodiment, for example, the ECU 20A supports driving of the moving body, and includes a margin estimation unit 20A1 as a functional component of controlling driving support. The margin estimation unit 20A1 estimates a margin in the driving status of the moving body, and determines, based on the margin, whether to allow another moving body, that is to merge with the traveling lane of the moving body, to merge in front of the moving body. The margin is a control parameter representing the degree of time margin, and the degree of time margin with respect to the scheduled time at which the moving body arrives at a destination is set as the margin.

The ECU 20A can modify the traveling speed of the moving body (self-vehicle) based on the margin estimated by the margin estimation unit 20A1. For example, if there is no time margin with respect to the scheduled arrival time, for example, there is a delay with respect to the scheduled arrival time, the ECU 20A can control the traveling speed of the moving body (self-vehicle) to increase the margin.

As a functional component concerning driving support control, the braking ECU 23A includes a braking control unit 23A1. The braking control unit 23A1 controls the braking unit (brake device 51) of the moving body, and the margin estimation unit 20A1 estimates a margin by decreasing the margin when the braking control unit 23A1 operates.

As a functional component concerning driving support control, the environment recognition ECU 21A includes a recognition processing unit 21A1. The recognition processing unit 21A1 recognizes the type of another moving body based on pieces of information acquired by external information acquisition units. The external information acquisition units include the detection units 31A (camera), 32A (LIDAR), and 32B (radar) that detect the peripheral status of the vehicle V, and the communication device 28c. The recognition processing unit 21A1 extracts, from image information detected by the detection units 31A (camera), 32A (LIDAR), and 32B (radar), information such as the length or height of another moving body, the area of another moving body included in an image frame, or the interval between the front and rear wheels of another moving body, and determines the type of the other moving body (other vehicle) based on the extraction result. For example, a large vehicle such as a truck or bus or a vehicle other the large vehicle can be determined. Alternatively, the recognition processing unit 21A1 can determine the type of another moving body (another vehicle) based on type information acquired by inter-vehicle communication or road-to-vehicle communication by the communication device 28c.

The margin estimation unit 20A1 estimates a margin in accordance with the type of another moving body. For example, if it is determined to allow another moving body of the second type (for example, a large vehicle such as a truck or bus) larger than another moving body of the first type (a small vehicle not included in a large vehicle such as a truck or bus) to merge in front of the moving body, the margin estimation unit 20A1 estimates a margin whose decrease amount is larger than that of a margin obtained when another moving body of the first type is allowed to merge.

As functional components concerning driving support control, the position recognition ECU 28A includes a route setting unit 28A1 that sets a predetermined route from a start point to a set destination based on car navigation settings, and a position information acquisition unit 28A2 that acquires the traveling position of the moving body along the set route.

Using the route set by the route setting unit 28A1 and the information of the traveling position of the moving body (self-vehicle) acquired by the position information acquisition unit 28A2, the margin estimation unit 20A1 calculates the degree of progress of traveling of the moving body along the route (the ratio of the traveled distance to the total traveling distance to the destination), and estimates, as a margin, the degree of time margin with respect to the scheduled time of arrival at the destination based on the degree of progress.

For example, the actual traveling time at the time of traveling of M % of the total traveling distance is represented by TR. When TM represents a halfway scheduled time at the time of traveling of M %, which has been converted from the scheduled time of arrival at the destination, the margin estimation unit 20A1 estimates, as the margin, the degree of time margin acquired based on the actual traveling time TR and the halfway scheduled time TM.

If the actual traveling time TR is earlier than the halfway scheduled time, the margin estimation unit 20A1 estimates to arrive at the destination at time earlier than the scheduled time. In this case, if it is estimated, based on the degree of progress of traveling of the moving body, to arrive at the destination at time earlier than the scheduled time, the margin estimation unit 20A1 increases the margin.

On the other hand, if the actual traveling time TR is later than the halfway scheduled time TM, the margin estimation unit 20A1 estimates to arrive at the destination at time later than the scheduled time. In this case, if it is estimated, based on the degree of progress of traveling of the moving body, to arrive at the destination at time later than the scheduled time, the margin estimation unit 20A1 decreases the margin. The margin estimation unit 20A1 successively calculates the degree of progress of traveling of the moving body, and estimates the margin based on the degree of progress.

If another moving body (another vehicle) is allowed to merge in front of the moving body (self-vehicle) based on the margin, the margin estimation unit 20A1 estimates a margin by decreasing the margin. In this case, the speed of the other moving body that has merged influences the self-vehicle to cause a temporal delay, and thus a margin is estimated by decreasing the margin.

The decrease amount of the margin caused by merging can be preset. In this case, it is possible to set the decrease amount of the margin based on the temporal delay which influences the moving body (self-vehicle) when another moving body merges. When Y(t) represents the margin estimated by the margin estimation unit 20A1 at time t, and α1 represents the decrease amount of the margin when one moving body merges, the margin estimation unit 20A1 estimates, as Y(t)−α1, a margin by merging. The decrease amount α1 of the margin corresponds to a temporal delay caused when one moving body is allowed to merge.

The margin estimation unit 20A1 determines, based on a result of comparing the margin (Y(t)−α1) with a threshold, whether another moving body is allowed to merge in front of the moving body (self-vehicle). If the margin (Y(t)−α1) decreased based on the predetermined decrease amount α1 is equal to or larger than the threshold, the margin estimation unit 20A1 permits merging in front of the moving body; otherwise, the margin estimation unit 20A1 does not permit (prohibits) merging in front of the moving body. In this case, if the margin is equal to or larger than the threshold, the margin estimation unit 20A1 determines that no delay is generated by merging with respect to the scheduled time, and permits merging; otherwise, the margin estimation unit 20A1 determines that a delay is generated by merging with respect to the scheduled time, and does not permit (prohibits) merging.

If a second another moving body is to merge with the traveling lane by following the other moving body, the margin estimation unit 20A1 determines, based on the margin, whether to allow the second another moving body to merge in front of the moving body. If it is determined to allow the second another moving body to merge in front of the moving body, the margin estimation unit 20A1 estimates a margin whose decrease amount is larger than that of the margin obtained when the other moving body is allowed to merge. In this case, when α2 represents the decrease amount of the margin obtained when the second moving body merges, the margin estimation unit 20A1 estimates, as Y(t)−α1−α2, a margin by merging of the second moving body.

Based on a result of comparing the margin (Y(t)−α1−α2) with the threshold, the margin estimation unit 20A1 determines whether to allow the other moving body to merge in front of the moving body (self-vehicle). If the margin (Y(t)−α1−α2) decreased based on a predetermined decrease amount (−α1−α2) is equal to or larger than the threshold, the margin estimation unit 20A1 permits merging in front of the moving body; otherwise, the margin estimation unit 20A1 does not permit (prohibits) merging in front of the moving body. That is, if the margin (Y(t)−α1−α2) is equal to or larger than the threshold, the margin estimation unit 20A1 determines that no delay is generated by merging with respect to the scheduled time, and permits merging; otherwise, the margin estimation unit 20A1 determines that a delay is generated by merging with respect to the scheduled time, and does not permit (prohibits) merging.

The decrease amount α2 of the margin when the second moving body merges is set larger than the decrease amount α1 of the margin when the first moving body merges. If only one moving body is allowed to merge in front of the moving body (self-vehicle), traveling of the one moving body influences traveling of the moving body. If two moving bodies are allowed to merge continuously, and traveling of one of them is slow, this influences traveling of the moving body (self-vehicle), and the temporal influence when allowing two moving bodies to merge continuously is larger than that when allowing only one moving body to merge twice. In addition, if two moving bodies are allowed to merge, it may be necessary to perform braking to ensure the distance to the preceding vehicle. If traveling of the moving body is delayed by braking, a temporal delay is generated by an amount of braking. Therefore, the decrease amount α2 of the margin when the second moving body merges is set larger than the decrease amount α1 of the margin when the first moving body merges.

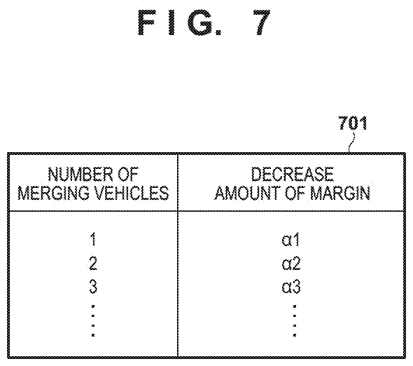

It is possible to set in advance the relationship between the number of merging moving bodies and the decrease amount of the margin in a table. As shown in, for example, FIG. 7, a table 701 that associates, with each other, the number of vehicles that merge with the traveling lane and the decrease amount of the margin caused when the vehicle is allowed to merge can be stored in advance in a storage unit 73 of the driving support apparatus 1, and the margin estimation unit 20A1 can estimate a margin based on the decrease amount acquired from the table 701.

<Control Procedure of Driving Support>

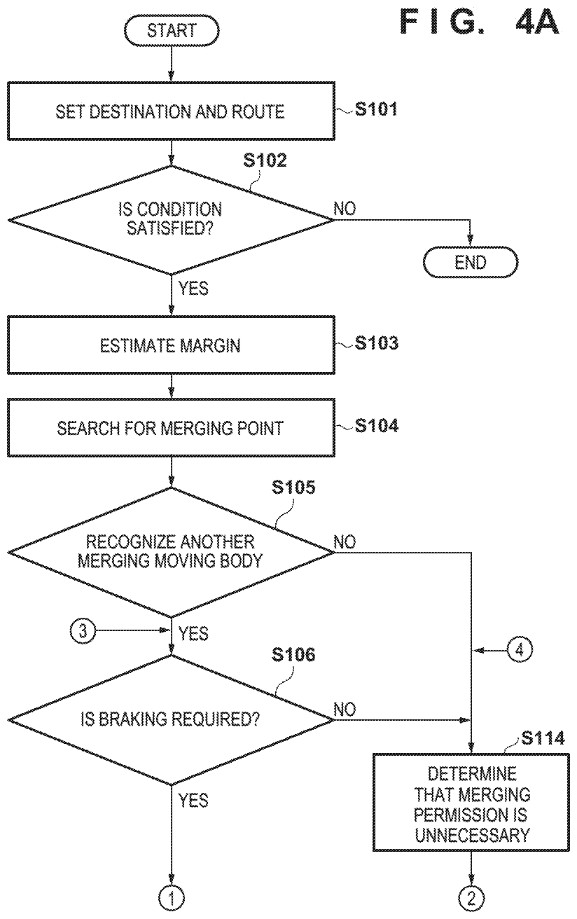

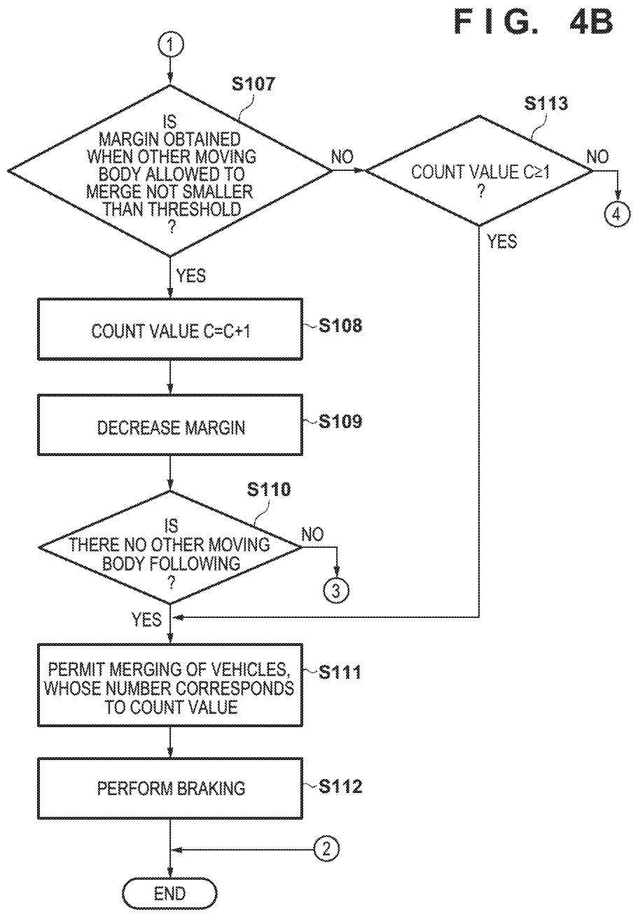

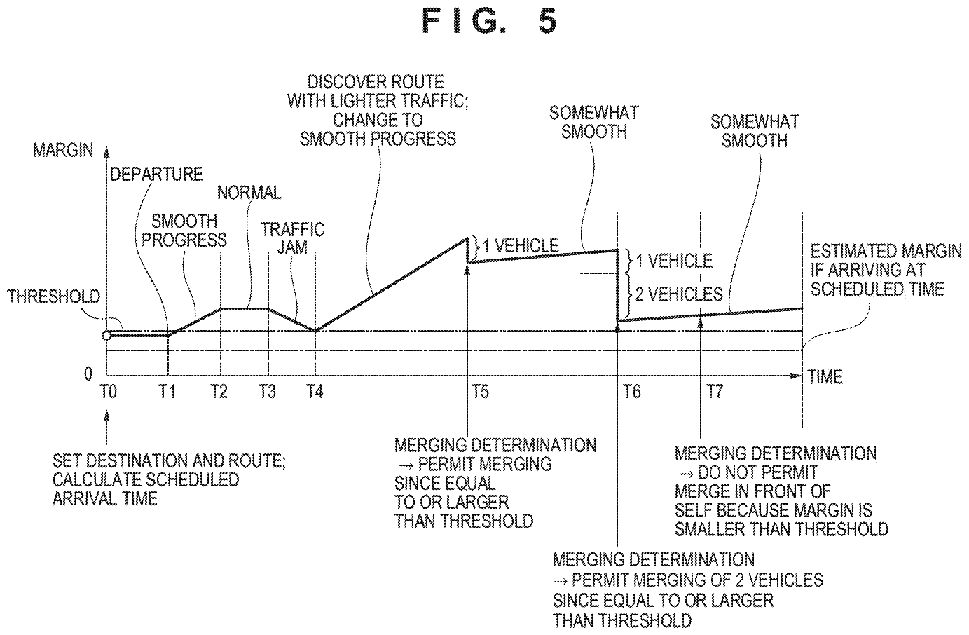

Detailed processing of the driving support apparatus 1 at the time of merging will be described next. FIGS. 4A and 4B are flowcharts for explaining the procedure of the processing of the driving support apparatus 1. FIG. 5 is a timing chart schematically showing a time-series change in margin, in which the abscissa represents the time and the ordinate represents the margin. Referring to FIG. 5, a solid line represents the margin, and a one-dot dashed line represents the estimated margin when the moving body arrives at the scheduled time. A two-dot dashed line indicates a threshold with a predetermine margin with respect to the estimated margin. This threshold can arbitrarily be set.

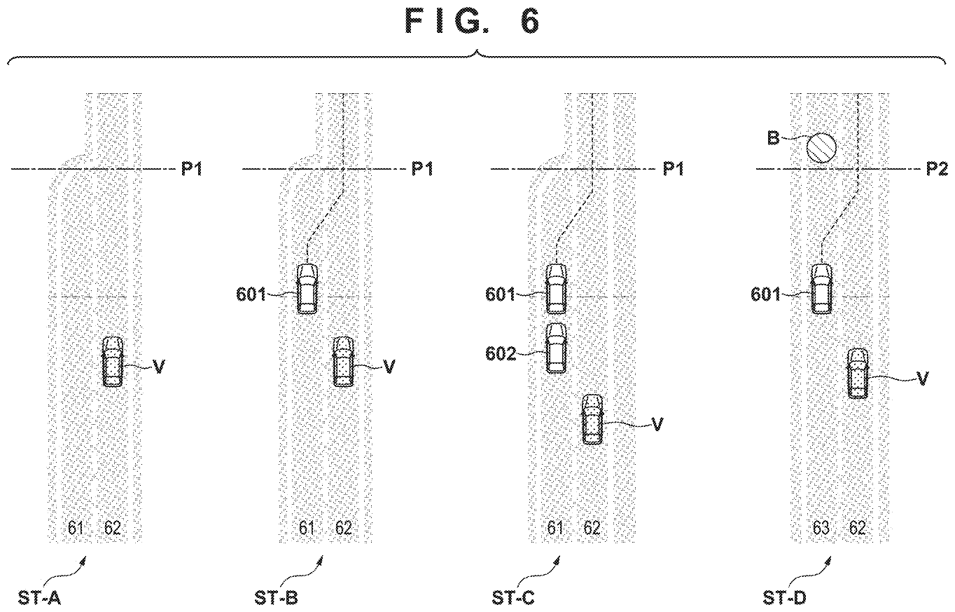

FIG. 6 is a view schematically showing traveling scenes. In FIG. 6, ST-A schematically shows a scene in which no other moving body (no other vehicle) travels near a merging point P1, and ST-B schematically shows a scene in which another moving body (another vehicle) 601 merges. In FIG. 6, ST-C schematically shows a scene in which two other moving bodies (other vehicles) 601 and 602 merge, and ST-D schematically shows a scene in which the other moving body (other vehicle) 601 enters a traveling lane 62 due to a lane change. The detailed processing of the driving support apparatus 1 will be described below with reference to FIGS. 4 to 6.

In step S101 of FIG. 4A, the user sets a destination in car navigation. After the destination is set, the route setting unit 28A1 sets a predetermined route from a start point to the set destination based on the car navigation settings. At this time, scheduled arrival time at which the user arrives at the destination from the start point is calculated.

The margin estimation unit 20A1 sets an estimated margin (one-dot dashed line in FIG. 5) when the user arrives at the scheduled time and a threshold (the two-dot dashed line in FIG. 5) with a predetermined margin with respect to the estimated margin.

The processing in step S101 of FIG. 4A corresponds to processing at time T0 in FIG. 5. The margin basically starts with zero. However, if there is a margin until the scheduled arrival time, the margin starts with a value on which the temporal margin is reflected. At this time, the margin estimation unit 20A1 can estimate the margin until the scheduled arrival time at the start based on car navigation information indicating that, for example, there is no traffic jam on the set route and information concerning the facial expression of the driver captured by an in-vehicle camera 31C. If there is a margin until the scheduled arrival time, the margin starts with a positive value, as shown in FIG. 5.

In step S102, the automated driving ECU 20A determines, for example, a condition that the driving support function or the automated driving function that provides a driving function more advanced than the driving support function is set in the vehicle V or a condition that setting of car navigation is complete. If the condition is not satisfied (NO in step S102), the process ends; otherwise (YES in step S102), the automated driving ECU 20A advances the process to step S103.

In step S103, the margin estimation unit 20A1 performs margin estimation processing in time series. If it is estimated, based on the degree of progress of traveling of the moving body, to arrive at the destination at time earlier than the scheduled time, the margin estimation unit 20A1 increases the margin. On the other hand, if it is estimated, based on the degree of progress of traveling of the moving body, to arrive at the destination at time later than the scheduled time, the margin estimation unit 20A1 decreases the margin.

In FIG. 5, during a period from time T0 to time T1, the vehicle V has not started and thus the margin remains unchanged. Then, the vehicle V starts at time T1, and the margin increases due to smooth progress until time T2. During a period from time T2 to time T3, the state is a traveling state (normal traveling state) as scheduled, and the margin is constant. During a period from time T3 to time T4, the set route is congested to cause a temporal delay, thereby decreasing the margin. The route setting unit 28A1 discovers a route having lighter traffic. During a period from time T4 to time T5, the degree of progress changes to smooth progress, and the margin increases.

In step S104, the automated driving ECU 20A searches for the merging point of another moving body (another vehicle) based on the pieces of information of the environment recognition ECU 21A and the position recognition ECU 28A. In step S105, the automated driving ECU 20A determines the presence/absence of a merging vehicle. If there is no merging vehicle (NO in step S105), the automated driving ECU 20A cannot recognize another moving body (another vehicle), and thus advances the process to step S114. The automated driving ECU 20A determines that merging permission is unnecessary, and the process ends. For example, if there is no merging vehicle at the merging point P1, as shown in ST-A of FIG. 6, the automated driving ECU 20A determines that merging permission is unnecessary, and the process ends.

On the other hand, if the automated driving ECU 20A determines, in step S105, based on the pieces of information of the environment recognition ECU 21A and the position recognition ECU 28A, that there is a merging vehicle (YES in step S105), the process advances to step S106. For example, if, as shown in ST-B of FIG. 6, there is a merging vehicle (the other moving body 601) at the merging point P1, the automated driving ECU 20A advances the process to step S106.

In step S106, the automated driving ECU 20A determines whether braking is required. If no braking is required (NO in step S106), the automated driving ECU 20A advances the process to step S114, in which the automated driving ECU 20A determines that merging permission is unnecessary, and the process ends. In this case, even if the moving body travels as scheduled, the other moving body can merge while ensuring a predetermined distance between the moving body (self-vehicle) and the other moving body (the other vehicle), and thus the margin estimation unit 20A1 determines that merging permission based on control at the time of merging according to this embodiment is unnecessary.

On the other hand, if braking is required in step S106 (YES in step S106), the automated driving ECU 20A advances the process to step S107.

In step S107, the margin estimation unit 20A1 determines whether the margin obtained when the other moving body (other vehicle) is allowed to merge is smaller than the threshold.

For example, the margin obtained when one merging vehicle (the other moving body 601) is allowed to merge, as shown in ST-B of FIG. 6, is estimated. When α1 represents the decrease amount of the margin when one vehicle merges, the margin estimation unit 20A1 can estimate, as Y(t)−α1, a margin by merging.

If the margin estimation unit 20A1 determines that the margin is smaller than the threshold (NO in step S107), it advances the process to step S113.

In step S113, the margin estimation unit 20A1 determines whether a count value of the number of merging vehicles is equal to or larger than 1. If the count value C is smaller than 1, that is, the number of merging vehicles is zero (NO in step S113), the margin estimation unit 20A1 advances the process to step S114, in which the automated driving ECU 20A determines that merging permission is unnecessary, and the process ends. In this case, there is no margin to permit merging by performing braking, and thus the margin estimation unit 20A1 determines that merging permission is unnecessary.

On the other hand, if the margin estimation unit 20A1 determines in step S107 that the margin obtained when another moving body (another vehicle) is allowed to merge is not smaller than the threshold, that is, the margin is equal to or larger than the threshold, the process advances to step S108 to count up the count value C of the number of merging vehicles. The initial value of the count value C is set to zero, and the count value C is counted up in this step. In this case, the count value is C=1.

In step S109, the margin estimation unit 20A1 decreases the margin based on the count value (C=1) of the number of merging vehicles. For example, if the count value C is 1 (one vehicle merges), the margin estimation unit 20A1 decreases the decrease amount α1 of the margin obtained when one vehicle merges. The decrease of the margin corresponds to the decrease of the margin at time T5 in FIG. 5.

Referring to FIG. 5, during a period from time T5 to time T6, the margin increases due to traveling (somewhat smooth traveling) with an increase rate of the margin lower than that of the margin during the period from time T4 to time T5, and the margin estimation unit 20A1 performs merging determination again at time T6. Processing of determining merging of one vehicle is similar to that in steps S104 to S109 described above.

In step S110, the margin estimation unit 20A determines the presence/absence of a subsequent moving body. For example, as shown in ST-C of FIG. 6, the margin estimation unit 20A1 determines whether the second another moving body 602 is to merge with the traveling lane 62 by following the other moving body 601. If there is the subsequent second another moving body 602 (NO in step S110), the process returns to step S106 to perform the same subsequent processes.

In step S106, the automated driving ECU 20A determines whether braking is required. If no braking is required (NO in step S106), the automated driving ECU 20A advances the process to step S114, in which the automated driving ECU 20A determines that merging permission is unnecessary, and the process ends. On the other hand, if it is determined in step S106 that braking is required (YES in step S106), the automated driving ECU 20A advances the process to step S107.

In step S107, the margin estimation unit 20A1 determines whether the margin obtained when the second another moving body (another vehicle) as the subsequent vehicle of the other moving body is allowed to merge is smaller than the threshold. For example, as shown in ST-C of FIG. 6, the margin when two merging vehicles (the other moving body 601 and the second another moving body 602) are allowed to merge is estimated. When α2 represents the decrease amount of the margin caused when the second vehicle merges, the margin estimation unit 20A1 can estimate, as Y(t)−α1−α2, a margin by merging.

If the margin estimation unit 20A1 determines that the margin is smaller than the threshold (NO in step S107), it advances the process to step S113.

In step S113, the margin estimation unit 20A1 determines whether the count value of the number of merging vehicles is equal to or larger than 1. If the count value is equal to or larger than 1, that is, the number of merging vehicles is equal to or larger than 1 (YES in step S113), the margin estimation unit 20A1 advances the process to step S111. In this case, since the margin (Y(t)−α1) is not smaller than the threshold when the first vehicle merges, the first vehicle is permitted to merge. However, if the margin (Y(t)−α1−α2) is smaller than the threshold when the second vehicle merges, the second vehicle is not permitted (prohibited) to merge.

On the other hand, if the margin estimation unit 20A1 determines in step S107 that the margin obtained when the two vehicles, that is, the other moving body and the second another moving body are allowed to merge is not smaller than the threshold, that is, the margin is equal to or larger than the threshold, the process advances to step S108 to count up the count value C of the number of merging vehicles. In this case, the count value is C=2.

In step S109, the margin estimation unit 20A1 decreases the margin based on the count value (C=2) of the number of merging vehicles. For example, if the count value C is 2 (two vehicles merge), the margin estimation unit 20A1 decrease the decrease amount (−α1−α2) of the margin caused when two vehicles merge. The decrease of the margin corresponds to the decrease of the margin at time T6 of FIG. 5.

Referring to FIG. 5, after time T6, the margin increases due to traveling (somewhat smooth traveling) with an increase rate of the margin lower than that of the margin during the period from time T4 to time T5, and the margin estimation unit 20A1 performs merging determination again at time T7. Processing of determining merging of one vehicle is similar to that in steps S104 to S109 described above. In this case, the margin estimation unit 20A1 determines that the margin obtained when the other moving body (other vehicle) is allowed to merge is smaller than the threshold, and determines that merging in front of the moving body (self-vehicle) is not permitted.

Then, in step S110, the margin estimation unit 20A1 determines the presence/absence of a subsequent moving body (for example, a third another moving body following the second another moving body 602 in ST-C of FIG. 6). If a subsequent moving body is absent (YES in step S110), the margin estimation unit 20A1 advances the process to step S111.

In step S111, based on the count value C of the number of merging vehicles, the margin estimation unit 20A1 permits merging of vehicles, the number of which corresponds to the count value. In step S112, under the control of the automated driving ECU 20A, the braking control unit 23A1 controls the braking unit (brake device 51) of the moving body to perform braking of the vehicle 1V and the process ends. According to driving support control of this embodiment, it is possible to perform driving support while keeping the balance between traveling of another moving body as a peripheral traffic environment and planned traveling of the moving body.

### Second Embodiment

The first embodiment has explained an example of merging of one vehicle with reference to ST-B of FIG. 6, and an example of merging of two vehicles with reference to ST-C of FIG. 6. The present invention, however, is not limited to them, and it is possible to determine merging of an arbitrary number of vehicles.

For example, if a count value C is N (merging of N vehicles: N is 3 or more), when the decrease amount of a margin at the time of merging of N vehicles is represented by αN ( . . . α3>α2>α1), a margin estimation unit 20A1 can estimate, as Y(t)−α1−α2−α3 . . . −αN, a margin by merging of N vehicles.

At this time, if braking control of a vehicle V at the time of merging becomes a braking allowable value in automated driving, driving support control processing and braking control processing in automated driving can be performed cooperatively.

### Third Embodiment

The first embodiment has explained an example in which another moving body or a second another moving body merges with the traveling lane 62, on which the moving body (self-vehicle) travels, from a merging lane 61 (ST-B or ST-C of FIG. 6). However, the present invention is also applicable to a lane change when there is an obstacle B (for example, a stopped vehicle) on an adjacent lane 63 at a lane change point P2, as shown in ST-D of FIG. 6. That is, even if another moving body 601 changes a lane from the lane 63 adjacent to a traveling lane 62, on which a moving body (self-vehicle) V travels, to the traveling lane 62, it is possible to apply driving support control based on a processing procedure at the time of merging determination.

### Fourth Embodiment

In the first embodiment, the margin estimation unit 20A1 estimates, as a margin, the degree of time margin with respect to the scheduled time of arrival at the destination based on the degree of progress of traveling of the moving body along the set route but may estimate the margin in consideration of the stress state of the driver in addition to the temporal aspect. For example, a margin estimation unit 20A1 may quantify the degree of stress of a driver based on information concerning the facial expression of the driver captured by an in-vehicle camera 31C, and reflect it on estimation of a margin as for the temporal aspect.

### Fifth Embodiment

In each of the above-described embodiments, the other moving body 601 and the second another moving body 602 have been explained as four-wheeled vehicles, as shown in ST-B and ST-C of FIG. 6. However, a vehicle entering (merging with or changing a lane to) a traveling lane 62 may be a two-wheeled vehicle including a bicycle, and it is possible to apply driving support control to a two-wheeled vehicle based on a processing procedure at the time of merging determination.

### Other Embodiments

A program for implementing each function of one or more driving support apparatuses described in the embodiments is supplied to a system or apparatus via a network or storage medium, and one or more processors in the computer of the system or apparatus can read out and execute the program. This form can also implement the present invention.

### Summary of Embodiments

Arrangement 1. A driving support apparatus according to the above embodiment is a driving support apparatus (for example, 1) for supporting driving of a moving body (for example, V in FIG. 1, 2), characterized by comprising:

a margin estimation unit (for example, 20A1 in FIG. 3) configured to estimate a margin in a driving status of the moving body,

wherein the margin estimation unit (20A1) determines, based on the margin, whether another moving body (for example, 601 in ST-B of FIG. 6) that is to merge with a traveling lane (for example, 62 in FIG. 6) of the moving body (V) is allowed to merge in front of the moving body.

In the driving support apparatus according to arrangement 1, it is possible to perform driving support while keeping the balance between traveling of the other moving body as a peripheral traffic environment and planned traveling of the moving body.

That is, in the driving support apparatus according to arrangement 1, it is possible to perform driving support while keeping the balance between traveling of the other moving body (other vehicle) as a peripheral traffic environment and planned traveling of the moving body (self-vehicle).

Arrangement 2. The driving support apparatus (1) according to the above embodiment is characterized by further comprising:

a route setting unit (for example, 28A1 in FIG. 3) configured to set a predetermined route from a start point to a set destination; and

a position information acquisition unit (for example, 28A2 in FIG. 3) configured to acquire a traveling position of the moving body along the route,

wherein the margin estimation unit (20A1) estimates, as the margin, a degree of time margin with respect to a scheduled time of arrival at the destination based on a degree of progress of traveling of the moving body (V) along the route.

In the driving support apparatus according to arrangement 2, by permitting merging when there is a margin in terms of the degree of progress, it is possible to perform driving support so as not to apply large stress to a driver while creating a smooth driving environment.

Arrangement 3. The driving support apparatus (1) according to the above embodiment is characterized in that if the other moving body (601) is allowed to merge in front of the moving body (V), the margin estimation unit (20A1) estimates a margin by decreasing the margin.

In the driving support apparatus according to arrangement 3, if the other moving body (other vehicle) is allowed to merge in front of the moving body (self-vehicle), the self-vehicle may be influenced by the speed of the other moving body, and thus a margin is estimated by decreasing the margin, thereby making it possible to readily estimate a mental margin of the driver.

Arrangement 4. The driving support apparatus (1) according to the above embodiment is characterized by further comprising a braking control unit (for example, 23A1 in FIG. 3) configured to control a braking unit of the moving body,

wherein when the braking control unit (23A1) operates, the margin estimation unit (20A1) estimates a margin by decreasing the margin.

In the driving support apparatus according to arrangement 4, if no braking is generated, it can be estimated to hardly influence the moving body (self-vehicle), and it is thus possible to readily estimate the margin of the driver.

Arrangement 5. The driving support apparatus (1) according to the above embodiment is characterized in that

if a second another moving body (for example 602 in ST-C of FIG. 6) is to merge with the traveling lane (602) by following the other moving body (601), the margin estimation unit (20A1) determines, based on the margin, whether to allow the second another moving body (602) to merge in front of the moving body (V), and

if it is determined to allow the second another moving body (602) to merge in front of the moving body, the margin estimation unit (20A1) estimates a margin whose decrease amount is larger than a decrease amount of a margin obtained when the other moving body (601) is allowed to merge.

In the driving support apparatus according to arrangement 5, allowing the second another moving body to merge generates large braking at the time of merging and largely influences the progress after merging and, thus, as estimation of the feeling of the driver, stress is estimated to be larger than that at the time of merging of the other moving body. Therefore, it is possible to estimate a value closer to the feeling by setting a large setting value of estimation.

Arrangement 6. The driving support apparatus (1) according to the above embodiment is characterized by further comprising a recognition processing unit (for example, 21A1 in FIG. 3) configured to recognize a type of the other moving body (601) based on information acquired by an external information acquisition unit (for example, camera 31A. LIDAR 32A, radar 32B, communication device 28c),

wherein the margin estimation unit (20A1) estimates the margin in accordance with the type, and

if it is determined to allow another moving body of a second type larger than another moving body of a first type to merge in front of the moving body, the margin estimation unit (20A1) estimates a margin whose decrease amount is larger than a decrease amount of a margin obtained when the other moving body of the first type is allowed to merge.

In the driving support apparatus according to arrangement 6, by estimating the margin based on the type of the other moving body to merge in front of the moving body, it is possible to readily estimate and predict the feeling of the driver.

Arrangement 7. The driving support apparatus (1) according to the above embodiment is characterized in that if it is estimated, based on the degree of progress of traveling of the moving body, to arrive at the destination at time earlier than the scheduled time, the margin estimation unit (20A1) increases the margin, and

if it is estimated, based on the degree of progress of traveling of the moving body, to arrive at the destination at time later than the scheduled time, the margin estimation unit (20A1) decreases the margin.

In the driving support apparatus according to arrangement 7, it is possible to estimate the margin in the driving status regardless of merging based on the degree of progress of traveling of the moving body.

Arrangement 8. The driving support apparatus (1) according to the above embodiment is characterized in that

the margin estimation unit (20A1) determines, based on a result of comparing the margin with a threshold, whether to allow the other moving body to merge in front of the moving body,

if the margin decreased based on a predetermined decrease amount is not smaller than the threshold, the margin estimation unit permits merging in front of the moving body, and

if the margin decreased based on the predetermined decrease amount is smaller than the threshold, the margin estimation unit (20A1) does not permit merging in front of the moving body.

In the driving support apparatus according to arrangement 8, it is possible to determine, based on the result of comparing the margin with the threshold, whether to permit merging in front of the moving body.

Arrangement 9. The driving support apparatus (1) according to the above embodiment is characterized by further comprising a storage unit (for example, 73 in FIG. 3) configured to store a table (for example, 701 in FIG. 7) that associates, with each other, the number of vehicles to merge with the traveling lane and a decrease amount of the margin when the vehicle is allowed to merge,

wherein the margin estimation unit (20A1) estimates the margin based on the decrease amount acquired from the table (701).

In the driving support apparatus according to arrangement 9, it is possible to readily acquire, with reference to the table, the decrease amount of the margin corresponding to the number of vehicles to merge.

Arrangement 10. A vehicle (for example, V) according to the above embodiment includes a driving support apparatus (for example, 1) defined in any one of arrangements 1 to 9.

According to the vehicle of arrangement 10, there can be provided a vehicle capable of performing driving support control while keeping the balance between traveling of the other moving body as a peripheral traffic environment and planned traveling of the moving body.

Arrangement 11. A control method for the driving support apparatus (1) according to the above embodiment is a control method for a driving support apparatus that supports driving of a moving body (for example, V), characterized by comprising:

a margin estimation step (for example, S103-S112 in FIGS. 4A and 4B) of estimating a margin in a driving status of the moving body (V),

wherein in the margin estimation step (S103-S112), it is determined, based on the margin, whether another moving body (for example, 601 in ST-B of FIG. 6) that is to merge with a traveling lane (for example, 62 in ST-B of FIG. 6) of the moving body (V) is allowed to merge in front of the moving body (for example, S107 in FIG. 4B).

In the control method for the driving support apparatus (1) according to arrangement 11, it is possible to perform driving support while keeping the balance between traveling of the other moving body as a peripheral traffic environment and planned traveling of the moving body. That is, it is possible to perform driving support while keeping the balance between traveling of the other moving body (other vehicle) as a peripheral traffic environment and planned traveling of the moving body (self-vehicle).

Arrangement 12. The control method for the driving support apparatus (1) according to the above embodiment is characterized by further comprising:

a route setting step (for example, S102 in FIG. 4A) of setting a predetermined route from a start point to a set destination; and

a position information acquisition step (for example, S102 in FIG. 4A) of acquiring a traveling position of the moving body along the route,

wherein in the margin estimation step (S103-S112), a degree of time margin with respect to a scheduled time of arrival at the destination is estimated as the margin based on a degree of progress of traveling of the moving body along the route.

In the control method for the driving support apparatus according to arrangement 12, it is possible to perform driving support while keeping the balance between traveling of the other moving body as a peripheral traffic environment and planned traveling of the moving body. That is, in the control method for the driving support apparatus, it is possible to perform driving support while keeping the balance between traveling of the other moving body (other vehicle) as a peripheral traffic environment and planned traveling of the moving body (self-vehicle).

Arrangement 13. The control method for the driving support apparatus (1) according to the above embodiment is characterized in that

if a second another moving body is to merge with the traveling lane by following the other moving body, whether to allow the second another moving body to merge in front of the moving body is determined based on the margin in the margin estimation step (S103-S112), and

if it is determined to allow the second another moving body to merge in front of the moving body, a margin whose decrease amount is larger than a decrease amount of a margin obtained when the other moving body is allowed to merge is estimated in the margin estimation step (S103-S112).

In the control method for the driving support apparatus according to arrangement 13, allowing the second another moving body to merge generates large braking at the time of merging and largely influences the progress after merging and, thus, as estimation of the feeling of the driver, stress is estimated to be larger than that at the time of merging of the other moving body. Therefore, it is possible to estimate a value closer to the feeling by setting a large setting value of estimation.

Arrangement 14. A driving support program according to the above embodiment causes a computer (for example, CPU) to execute each step (for example, S103-S112) of a control method for a driving support apparatus defined in any one of arrangements 11 to 13.

According to the driving support program of arrangement 14, there can be provided a program capable of performing driving support while keeping the balance between traveling of the other moving body as a peripheral traffic environment and planned traveling of the moving body.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. A driving support apparatus for supporting driving of a moving body, comprising:
a margin estimation unit configured to estimate a margin in a driving status of the moving body,
wherein the margin estimation unit determines, based on the margin, whether another moving body that is to merge with a traveling lane of the moving body is allowed to merge in front of the moving body.

2. The apparatus according to claim 1, further comprising:
a route setting unit configured to set a predetermined route from a start point to a set destination; and
a position information acquisition unit configured to acquire a traveling position of the moving body along the route,
wherein the margin estimation unit estimates, as the margin, a degree of time margin with respect to a scheduled time of arrival at the destination based on a degree of progress of traveling of the moving body along the route.

3. The apparatus according to claim 1, wherein if the other moving body is allowed to merge in front of the moving body, the margin estimation unit estimates a margin by decreasing the margin.

4. The apparatus according to claim 1, further comprising a braking control unit configured to control a braking unit of the moving body,
wherein when the braking control unit operates, the margin estimation unit estimates a margin by decreasing the margin.

5. The apparatus according to claim 1, wherein
if a second another moving body is to merge with the traveling lane by following the other moving body, the margin estimation unit determines, based on the margin, whether to allow the second another moving body to merge in front of the moving body, and
if it is determined to allow the second another moving body to merge in front of the moving body, the margin estimation unit estimates a margin whose decrease amount is larger than a decrease amount of a margin obtained when the other moving body is allowed to merge.

6. The apparatus according to claim 1, further comprising a recognition processing unit configured to recognize a type of the other moving body based on information acquired by an external information acquisition unit,
wherein the margin estimation unit estimates the margin in accordance with the type, and
if it is determined to allow another moving body of a second type larger than another moving body of a first type to merge in front of the moving body, the margin estimation unit estimates a margin whose decrease amount is larger than a decrease amount of a margin obtained when the other moving body of the first type is allowed to merge.

7. The apparatus according to claim 2, wherein
if it is estimated, based on the degree of progress of traveling of the moving body, to arrive at the destination at time earlier than the scheduled time, the margin estimation unit increases the margin, and
if it is estimated, based on the degree of progress of traveling of the moving body, to arrive at the destination at time later than the scheduled time, the margin estimation unit decreases the margin.

8. The apparatus according to claim 1, wherein
the margin estimation unit determines, based on a result of comparing the margin with a threshold, whether to allow the other moving body to merge in front of the moving body,
if the margin decreased based on a predetermined decrease amount is not smaller than the threshold, the margin estimation unit permits merging in front of the moving body, and
if the margin decreased based on the predetermined decrease amount is smaller than the threshold, the margin estimation unit does not permit merging in front of the moving body.

9. The apparatus according to claim 8, further comprising a storage unit configured to store a table that associates, with each other, the number of vehicles to merge with the traveling lane and a decrease amount of the margin when the vehicle is allowed to merge,
wherein the margin estimation unit estimates the margin based on the decrease amount acquired from the table.

10. A vehicle including a driving support apparatus defined in claim 1.

11. A control method for a driving support apparatus that supports driving of a moving body, comprising:
a margin estimation step of estimating a margin in a driving status of the moving body,
wherein in the margin estimation step, it is determined, based on the margin, whether another moving body that is to merge with a traveling lane of the moving body is allowed to merge in front of the moving body.

12. The method according to claim 11, further comprising:
a route setting step of setting a predetermined route from a start point to a set destination; and
a position information acquisition step of acquiring a traveling position of the moving body along the route,
wherein in the margin estimation step, a degree of time margin with respect to a scheduled time of arrival at the destination is estimated as the margin based on a degree of progress of traveling of the moving body along the route.

13. The method according to claim 11, wherein
if a second another moving body is to merge with the traveling lane by following the other moving body, whether to allow the second another moving body to merge in front of the moving body is determined based on the margin in the margin estimation step, and
if it is determined to allow the second another moving body to merge in front of the moving body, a margin whose decrease amount is larger than a decrease amount of a margin obtained when the other moving body is allowed to merge is estimated in the margin estimation step.

14. A storage medium storing a driving support program for causing a computer to execute each step of a control method for a driving support apparatus defined in claim 11.
